(19) United States
(12) Patent Application Publication
(10) Pub. No.: US 2024/0300527 A1
(43) Pub. Date: Sep. 12, 2024

(54) DIFFUSION FOR REALISTIC SCENE GENERATION

(71) Applicant: Waabi Innovation Inc., Toronto (CA)

(72) Inventors: Jack LU, Toronto (CA); Kelvin WONG, Toronto (CA); Chris ZHANG, Toronto (CA); Simon SUO, Toronto (CA); Raquel URTASUN, Toronto (CA)

(73) Assignee: Waabi Innovation Inc., Toronto, ON (CA)

(21) Appl. No.: 18/598,970

(22) Filed: Mar. 7, 2024

Related U.S. Application Data
(60) Provisional application No. 63/450,904, filed on Mar. 8, 2023.

(51) Int. Cl. B60W 60/00; B60W 50/00; G06N 5/022

(52) U.S. Cl. CPC B60W 60/001; B60W 50/00; G06N 5/022; B60W 2556/25

(57) ABSTRACT

Diffusion for realistic scene generation includes obtaining a current set of agent state vectors and a map data of a geographic region, and iteratively, through multiple diffusion timesteps, updating the current set of agent state vectors. Iteratively updating includes processing, by a noise prediction model, the current set of agent state vectors, a current diffusion timestep of the plurality of diffusion timesteps, and the map data to obtain a noise prediction value, generating a mean using the noise prediction value, generating a distribution function according to the mean, sampling a revised set of agent state vectors from the distribution function, and replacing the current set of agent state vectors with the revised set of agent state vectors. The current set of agent state vectors are outputted.

### CROSS REFERENCE TO RELATED APPLICATIONS

This application is a non-provisional application of, and thereby claims benefit to, U.S. Patent Application Ser. No. 63/450,904 filed on Mar. 8, 2023. U.S. Patent Application Ser. No. 63/450,904 is incorporated herein by reference in its entirety.

### BACKGROUND

A virtual world is an environment in which a player may move in three dimensions as if the player were in the real world. The player operates independently of the instructions of the virtual world. In addition to the player, the virtual world may also have computerized agents that are part of the virtual world. Similar to the player, the agents also move through the virtual world. In some virtual worlds, a goal of the virtual world is to be realistic or to have some elements of realism. Thus, even if the virtual world is not a replica of the real world, the virtual world has elements that could be in the real world. One source of realism is the initial placement of the agents in the virtual world. Namely, a goal is that the initial scene has agents in the virtual world in the same way that the agents might be in the real world.

### SUMMARY

In general, in one aspect, one or more embodiments relate to a method. The method includes obtaining a current set of agent state vectors and a map data of a geographic region, and iteratively, through multiple diffusion timesteps, updating the current set of agent state vectors. Iteratively updating includes processing, by a noise prediction model, the current set of agent state vectors, a current diffusion timestep of the plurality of diffusion timesteps, and the map data to obtain a noise prediction value, generating a mean using the noise prediction value, generating a distribution function according to the mean, sampling a revised set of agent state vectors from the distribution function, and replacing the current set of agent state vectors with the revised set of agent state vectors. The method further includes outputting the current set of agent state vectors.

In general, in one aspect, one or more embodiments relate to a system that includes a computer processor and a non-transitory computer readable medium for causing the computer processor to perform operations. The operations include includes obtaining a current set of agent state vectors and a map data of a geographic region, and iteratively, through multiple diffusion timesteps, updating the current set of agent state vectors. Iteratively updating includes processing, by a noise prediction model, the current set of agent state vectors, a current diffusion timestep of the plurality of diffusion timesteps, and the map data to obtain a noise prediction value, generating a mean using the noise prediction value, generating a distribution function according to the mean, sampling a revised set of agent state vectors from the distribution function, and replacing the current set of agent state vectors with the revised set of agent state vectors. The operations further include outputting the current set of agent state vectors.

In general, in one aspect, one or more embodiments relate to a non-transitory computer readable medium that includes computer readable program code for causing a computer system to perform operations. The operations include includes obtaining a current set of agent state vectors and a map data of a geographic region, and iteratively, through multiple diffusion timesteps, updating the current set of agent state vectors. Iteratively updating includes processing, by a noise prediction model, the current set of agent state vectors, a current diffusion timestep of the plurality of diffusion timesteps, and the map data to obtain a noise prediction value, generating a mean using the noise prediction value, generating a distribution function according to the mean, sampling a revised set of agent state vectors from the distribution function, and replacing the current set of agent state vectors with the revised set of agent state vectors. The operations further include outputting the current set of agent state vectors.

Other aspects of the invention will be apparent from the following description and the appended claims.

### BRIEF DESCRIPTION OF DRAWINGS

FIG. 1 shows a diagram of a simulator for testing or training an autonomous system with a virtual driver in accordance with one or more embodiments.

FIG. 2 shows a flowchart for performing a simulation for training a virtual driver in accordance with one or more embodiments of the invention.

FIG. 3 shows a diagram of a scene generator in accordance with one or more embodiments of the invention.

FIG. 4 shows a diagram of a noise prediction model in accordance with one or more embodiments of the invention.

FIG. 5 shows a flowchart for diffusion for realistic scene generation in accordance with one or more embodiments of the invention.

FIG. 6 shows an example flow diagram of realistic scene generation in accordance with one or more embodiments of the invention.

FIG. 7 shows an example diffusion process without constraints in accordance with one or more embodiments.

FIG. 8 shows an example diffusion process with constraints in accordance with one or more embodiments.

FIGS. 9A and 9B show a computing system in accordance with one or more embodiments of the invention.

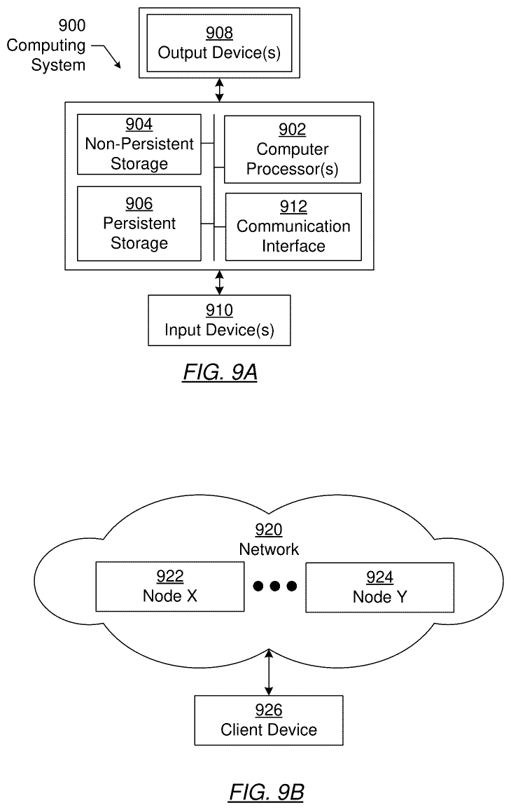

Like elements in the various figures are denoted by like reference numerals for consistency.

### DETAILED DESCRIPTION

In general, embodiments are directed to a diffusion model for performing realistic initial scene generation. Specifically, one or more embodiments are directed to initial placement of agents in a virtual world at the start of a scene. The virtual world is an environment in which at least one independent player may move in three dimensions as if the player were in the real world. The player in the virtual world may be a human, a virtual driver of an autonomous system, or other computer software. The virtual world may also include computerized agents that may also move through the virtual world like the player. A scene generator controls initial states of the agents in the virtual world. For example, the initial states may include attributes of the placement of the agents, the size and type of agents, and other aspects. To be realistic, agents should initially appear in the virtual world similar to how agents might be in the real world. For example, if an agent is a car, the agent should not be on a sidewalk in the initial placement.

In some applications, hundreds of thousands of initial scenes for various scenarios should be generated within a shortened time limit that is cost prohibitive for a user to generate. Moreover, in some cases, users have biases that do not generate fully randomized scenes. In such cases, the initial scenes may be skewed to a preset set of properties. One or more embodiments include a diffusion model that performs initial scene generation. The diffusion model learns how to transform randomly generated agent states into realistic set of agent states that could potentially exist in the real world.

Briefly, a diffusion model is a model that learns to reverse a forward diffusion process. For the forward diffusion process, the diffusion model starts from real-world agent states that are sampled from the real-world. The real-world sampled data is iteratively corrupted with a noise sample. The noise sample is sampled from a Gaussian distribution function over a set of diffusion timesteps (e.g., five hundred to a thousand timesteps). A noise schedule is used to perform the diffusion. The forward diffusion process yields a chain of agent states that are more and more corrupt. The agents, therefore, would appear less and less realistic in the chain of agent states. At the end of the forward diffusion process, the final set of agent states may be the same as if randomly sampled from a normal distribution.

The diffusion model performs the reverse diffusion process. The reverse diffusion process starts with randomly generated agent state vectors and generates agent states that match a real-world distribution. At each diffusion timestep of the reverse diffusion process, the diffusion model attempts to reverse the noise added to generate the current set of agent states. Thus, whereas the forward diffusion process iteratively corrupts realistic agent states, the reverse diffusion process attempts to remove noise to iteratively make the agent states appear more realistic. To perform the reverse diffusion process, the mean of a distribution function is parameterized by a noise prediction model. The noise prediction model is a machine learning model that is configured to generate a noise prediction value. The noise prediction value is a value configured to predict a level of noise at the current set of agent states.

In at least some embodiments, the diffusion model is capable of generating randomized, realistic agent states that are constrained by a guidance function. The guidance function is a function that perturbs the agent states during the diffusion process so that the agent states over the course of the diffusion process comply with a set of constraints. Because the guidance function perturbs the agent states over the course of the diffusion process, the output may reflect the range of agent states that satisfy the constraints. The constraints may be defined, for example, by user input and used to generate a wide range of initial scenes.

Embodiments of the invention may be used as part of generating a simulated environment for the training and testing of autonomous systems. An autonomous system is a self-driving mode of transportation that does not require a human pilot or human driver to move and react to the real-world environment. Rather, the autonomous system includes a virtual driver that is the decision-making portion of the autonomous system. The virtual driver is an artificial intelligence system that learns how to interact in the real world. The autonomous system may be completely autonomous or semi-autonomous. As a mode of transportation, the autonomous system is contained in a housing configured to move through a real-world environment. Examples of autonomous systems include self-driving vehicles (e.g., self-driving trucks and cars), drones, airplanes, robots, etc. The virtual driver is the software that makes decisions and causes the autonomous system to interact with the real-world including moving, signaling, and stopping or maintaining a current state.

The real-world environment is the portion of the real world through which the autonomous system, when trained, is designed to move. Thus, the real-world environment may include interactions with concrete and land, people, animals, other autonomous systems, human driven systems, construction, and other objects as the autonomous system moves from an origin to a destination. In order to interact with the real-world environment, the autonomous system includes various types of sensors, such as LiDAR sensors amongst other types, which are used to obtain measurements of the real-world environment, and cameras that capture images from the real-world environment.

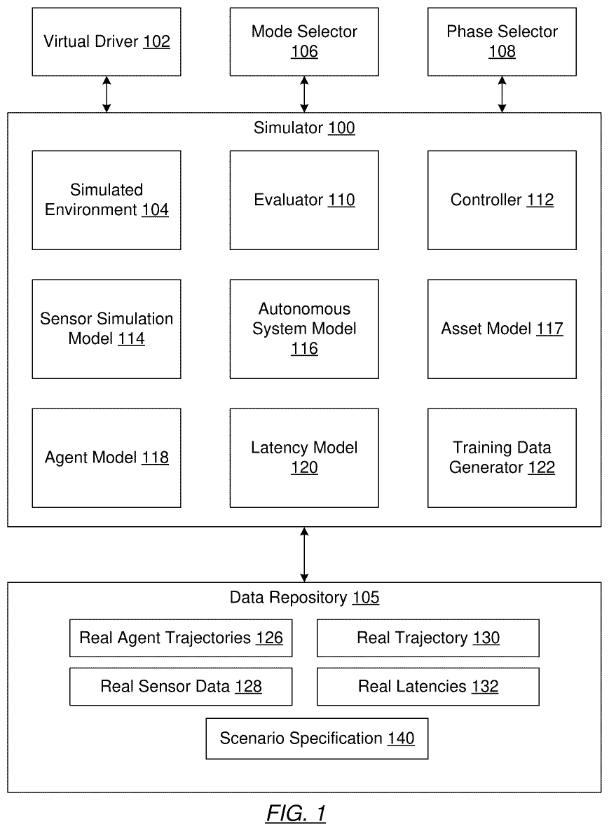

The testing and training of the virtual driver of the autonomous systems in the real-world environment is unsafe because of the accidents that an untrained virtual driver can cause. Thus, as shown in FIG. 1, a simulator (100) is configured to train and test a virtual driver (102) of an autonomous system. For example, the simulator may be a unified, modular, mixed-reality, closed-loop simulator for autonomous systems. The simulator (100) is a configurable simulation framework that enables not only evaluation of different autonomy components in isolation but also as a complete system in a closed-loop manner. The simulator reconstructs “digital twins” of real-world scenarios automatically, enabling accurate evaluation of the virtual driver at scale. The simulator (100) may also be configured to perform mixed-reality simulation that combines real world data and simulated data to create diverse and realistic evaluation variations to provide insight into the virtual driver's performance. The mixed reality closed-loop simulation allows the simulator (100) to analyze the virtual driver's action on counterfactual “what-if” scenarios that did not occur in the real-world. The simulator (100) further includes functionality to simulate and train on rare yet safety-critical scenarios with respect to the entire autonomous system and closed-loop training to enable automatic and scalable improvement of autonomy.

The simulator (100) creates the simulated environment (104) which is a virtual world. The virtual driver (102) is the player in the virtual world. The simulated environment (104) is a simulation of a real-world environment, which may or may not be in actual existence, in which the autonomous system is designed to move. As such, the simulated environment (104) includes a simulation of the objects (i.e., simulated objects or assets) and background in the real world, including the natural objects, construction, buildings and roads, obstacles, as well as other autonomous and non-autonomous objects. The simulated environment simulates the environmental conditions within which the autonomous system may be deployed. Additionally, the simulated environment (104) may be configured to simulate various weather conditions that may affect the inputs to the autonomous systems. The simulated objects may include both stationary and nonstationary objects. Nonstationary objects are agents in the real-world environment.

The simulator (100) also includes an evaluator (110). The evaluator (110) is configured to train and test the virtual driver (102) by creating various scenarios in the simulated environment. Each scenario is a configuration of the simulated environment including, but not limited to, static portions, movement of simulated objects, actions of the simulated objects with each other, and reactions to actions taken by the autonomous system and simulated objects. The evaluator (110) is further configured to evaluate the performance of the virtual driver using a variety of metrics.

The evaluator (110) assesses the performance of the virtual driver throughout the performance of the scenario. Assessing the performance may include applying rules. For example, the rules may be that the automated system does not collide with any other agent, compliance with safety and comfort standards (e.g., passengers not experiencing more than a certain acceleration force within the vehicle), the automated system not deviating from executed trajectory), or other rule. Each rule may be associated with the metric information that relates a degree of breaking the rule with a corresponding score. The evaluator (110) may be implemented as a data-driven neural network that learns to distinguish between good and bad driving behavior. The various metrics of the evaluation system may be leveraged to determine whether the automated system satisfies the requirements of the success criterion for a particular scenario. Further, in addition to system level performance, for modular based virtual drivers, the evaluator may also evaluate individual modules such as segmentation or prediction performance for agents in the scene with respect to the ground truth recorded in the simulator.

The simulator (100) is configured to operate in multiple phases as selected by the phase selector (108) and modes as selected by a mode selector (106). The phase selector (108) and mode selector (106) may be a graphical user interface or application programming interface component that is configured to receive a selection of phase and mode, respectively. The selected phase and mode define the configuration of the simulator (100). Namely, the selected phase and mode define which system components communicate and the operations of the system components.

The phase may be selected using a phase selector (108). The phase may be a training phase or a testing phase. In the training phase, the evaluator (110) provides metric information to the virtual driver (102), which uses the metric information to update the virtual driver (102). The evaluator (110) may further use the metric information to further train the virtual driver (102) by generating scenarios for the virtual driver. In the testing phase, the evaluator (110) does not provide the metric information to the virtual driver. In the testing phase, the evaluator (110) uses the metric information to assess the virtual driver and to develop scenarios for the virtual driver (102).

The mode may be selected by the mode selector (106). The mode defines the degree to which real-world data is used, whether noise is injected into simulated data, the degree of perturbations of real-world data, and whether the scenarios are designed to be adversarial. Example modes include open loop simulation mode, closed loop simulation mode, single module closed loop simulation mode, fuzzy mode, and adversarial mode. In an open loop simulation mode, the virtual driver is evaluated with real world data. In a single module closed loop simulation mode, a single module of the virtual driver is tested. An example of a single module closed loop simulation mode is a localizer closed loop simulation mode in which the simulator evaluates how the localizer estimated pose drifts over time as the scenario progresses in simulation. In a training data simulation mode, simulator is used to generate training data. In a closed loop evaluation mode, the virtual driver and simulation system are executed together to evaluate system performance. In the adversarial mode, the agents are modified to perform adversarial. In the fuzzy mode, noise is injected into the scenario (e.g., to replicate signal processing noise and other types of noise). Other modes may exist without departing from the scope of the system.

The simulator (100) includes the controller (112) which includes functionality to configure the various components of the simulator (100) according to the selected mode and phase. Namely, the controller (112) may modify the configuration of each of the components of the simulator based on the configuration parameters of the simulator (100). Such components include the evaluator (110), the simulated environment (104), an autonomous system model (116), sensor simulation models (114), asset models (117), agent models (118), latency models (120), and a training data generator (122).

The autonomous system model (116) is a detailed model of the autonomous system in which the virtual driver will execute. The autonomous system model (116) includes model, geometry, physical parameters (e.g., mass distribution, points of significance), engine parameters, sensor locations and type, the firing pattern of the sensors, information about the hardware on which the virtual driver executes (e.g., processor power, amount of memory, and other hardware information), and other information about the autonomous system. The various parameters of the autonomous system model may be configurable by the user or another system.

For example, if the autonomous system is a motor vehicle, the modeling and dynamics may include the type of vehicle (e.g., car, truck), make and model, geometry, physical parameters such as the mass distribution, axle positions, type and performance of the engine, etc. The vehicle model may also include information about the sensors on the vehicle (e.g., camera, LiDAR, etc.), the sensors' relative firing synchronization pattern, and the sensors' calibrated extrinsics (e.g., position and orientation) and intrinsics (e.g., focal length). The vehicle model also defines the onboard computer hardware, sensor drivers, controllers, and the autonomy software release under test.

The autonomous system model includes an autonomous system dynamic model. The autonomous system dynamic model is used for dynamics simulation that takes the actuation actions of the virtual driver (e.g., steering angle, desired acceleration) and enacts the actuation actions on the autonomous system in the simulated environment to update the simulated environment and the state of the autonomous system. To update the state, a kinematic motion model may be used, or a dynamics motion model that accounts for the forces applied to the vehicle may be used to determine the state. Within the simulator, with access to real log scenarios with ground truth actuations and vehicle states at each time step, embodiments may also optimize analytical vehicle model parameters or learn parameters of a neural network that infers the new state of the autonomous system given the virtual driver outputs.

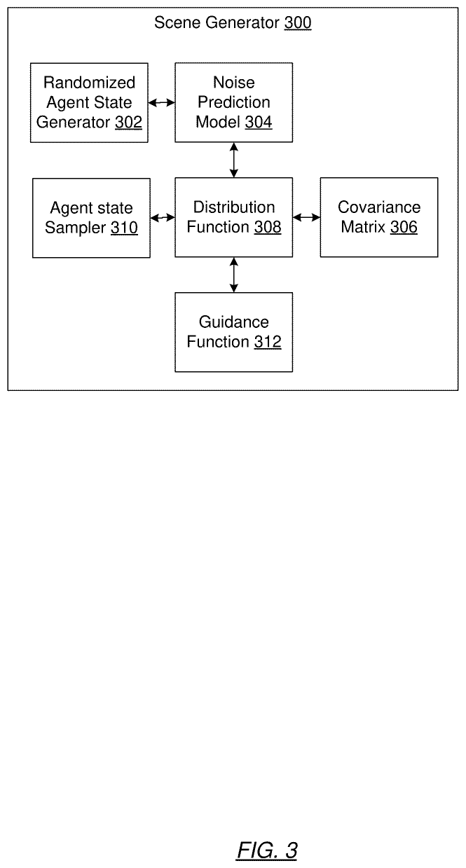

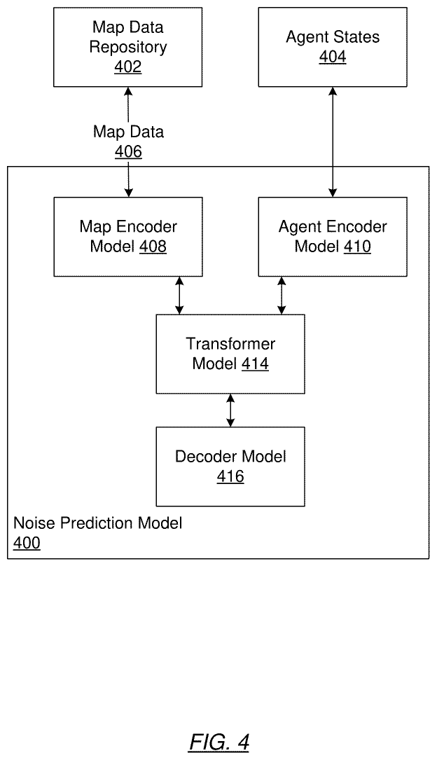

In one or more embodiments, the sensor simulation models (114) models, in the simulated environment, active and passive sensor inputs. Passive sensor inputs capture the visual appearance of the simulated environment including stationary and nonstationary simulated objects from the perspective of one or more cameras based on the simulated position of the camera(s) within the simulated environment. Examples of passive sensor inputs include inertial measurement unit (IMU) and thermal. Active sensor inputs are inputs to the virtual driver of the autonomous system from the active sensors, such as LiDAR, RADAR, global positioning system (GPS), ultrasound, etc. Namely, the active sensor inputs include the measurements taken by the sensors, and the measurements being simulated based on the simulated environment based on the simulated position of the sensor(s) within the simulated environment. By way of an example, the active sensor measurements may be measurements that a LiDAR sensor would make of the simulated environment over time and in relation to the movement of the autonomous system. In one or more embodiments, all or a portion of the sensor simulation models (114) may be or include the rendering system (300) shown in FIG. 3. In such a scenario, the rendering system of the sensor simulation models (114) may perform the operations of FIGS. 4-6.

The sensor simulation models (114) are configured to simulate the sensor observations of the surrounding scene in the simulated environment (104) at each time step according to the sensor configuration on the vehicle platform. When the simulated environment directly represents the real-world environment, without modification, the sensor output may be directly fed into the virtual driver. For light-based sensors, the sensor model simulates light as rays that interact with objects in the scene to generate the sensor data. Depending on the asset representation (e.g., of stationary and nonstationary objects), embodiments may use graphics-based rendering for assets with textured meshes, neural rendering, or a combination of multiple rendering schemes. Leveraging multiple rendering schemes enables customizable world building with improved realism. Because assets are compositional in 3D and support a standard interface of render commands, different asset representations may be composed in a seamless manner to generate the final sensor data. Additionally, for scenarios that replay what happened in the real world and use the same autonomous system as in the real world, the original sensor observations may be replayed at each time step.

Asset models (117) include multiple models, each model modeling a particular type of individual asset in the real world. The assets may include inanimate objects such as construction barriers or traffic signs, parked cars, and background (e.g., vegetation or sky). Each of the entities in a scenario may correspond to an individual asset. As such, an asset model, or instance of a type of asset model, may exist for each of the objects or assets in the scenario. The assets can be composed together to form the three-dimensional simulated environment. An asset model provides all the information needed by the simulator to simulate the asset. The asset model provides the information used by the simulator to represent and simulate the asset in the simulated environment.

Closely related to, and possibly considered part of, the set of asset models (117) are agent models (118). An agent model represents an agent in a scenario. An agent is a sentient being that has an independent decision-making process. Namely, in the real world, the agent may be animate being (e.g., a person or animal) that makes a decision based on an environment. The agent makes active movement rather than or in addition to passive movement. An agent model, or an instance of an agent model may exist for each agent in a scenario. The agent model is a model of the agent. If the agent is in a mode of transportation, then the agent model includes the model of transportation in which the agent is located. For example, agent models may represent pedestrians, children, vehicles being driven by drivers, pets, bicycles, and other types of agents.

The agent model leverages the scenario specification and assets to control all agents in the scene and their actions at each time step. The agent's behavior is modeled in a region of interest centered around the autonomous system. Depending on the scenario specification, the agent simulation will control the agents in the simulation to achieve the desired behavior. Agents can be controlled in various ways. One option is to leverage heuristic agent models, such as an intelligent-driver model (IDM) that try to maintain a certain relative distance or time-to-collision (TTC) from a lead agent or heuristic-derived lane-change agent models. Another is to directly replay agent trajectories from a real log or to control the agent(s) with a data-driven traffic model. Through the configurable design, embodiments may mix and match different subsets of agents to be controlled by different behavior models. For example, far-away agents that initially may not interact with the autonomous system and can follow a real log trajectory, but when near the vicinity of the autonomous system may switch to a data-driven agent model. In another example, agents may be controlled by a heuristic or data-driven agent model that still conforms to the high-level route in a real-log. This mixed-reality simulation provides control and realism.

Further, agent models may be configured to be in cooperative or adversarial mode. In cooperative mode, the agent model models agents to act rationally in response to the state of the simulated environment. In adversarial mode, the agent model may model agents acting irrationally, such as exhibiting road rage and bad driving.

The latency model (120) represents timing latency that occurs when the autonomous system is in a real-world environment. Several sources of timing latency may exist. For example, a latency may exist from the time that an event occurs to the sensors detecting the sensor information from the event and sending the sensor information to the virtual driver. Another latency may exist based on the difference between the computing hardware executing the virtual driver in the simulated environment as compared to the computing hardware of the virtual driver. Further, another timing latency may exist between the time that the virtual driver transmits an actuation signal to the autonomous system changing (e.g., direction or speed) based on the actuation signal. The latency model (120) models the various sources of timing latency.

Stated another way, in the real world, safety-critical decisions in the real world may involve fractions of a second affecting response time. The latency model simulates the exact timings and latency of different components of the onboard system. To enable scalable evaluation without strict requirements on exact hardware, the latencies and timings of the different components of the autonomous system and sensor modules are modeled while running on different computer hardware. The latency model may replay latencies recorded from previously collected real world data or have a data-driven neural network that infers latencies at each time step to match the hardware in a loop simulation setup.

The training data generator (122) is configured to generate training data. For example, the training data generator (122) may modify real-world scenarios to create new scenarios. The modification of real-world scenarios is referred to as mixed reality. For example, mixed-reality simulation may involve adding in new agents with novel behaviors, changing the behavior of one or more of the agents from the real-world, and modifying the sensor data in that region while keeping the remainder of the sensor data the same as the original log. In some cases, the training data generator (122) converts a benign scenario into a safety-critical scenario.

Specifying realistic scenarios may be decomposed into two tasks: (1) specifying the initial placement and attributes of the agents in a scene; and (2) unrolling a policy to simulate the agents' behaviors. The training data generator (122) is configured to generate scenes that capture the nuanced interactions between agents in the real world in a scalable manner across a diversity of road topologies, and realistically. Thus, the simulation accurately reflects what may occur in the real world (e.g., the agents' initial kinematics should not induce inevitable collisions when unrolling the simulation). By implementing a diffusion model, the number of scenes that may be generated reflects the wide range of possible traffic patterns. The training data generator (122) is an example of the scene generator (300) in FIG. 3. Specifically, the training data generator (122) is a scene generator which has output for training the virtual driver.

The simulator (100) is connected to a data repository (105). The data repository (105) is any type of storage unit or device that is configured to store data. The data repository (105) includes data gathered from the real world. For example, the data gathered from the real world include real agent trajectories (126), real sensor data (128), real trajectories of the system capturing the real world (130), and real latencies (132). Each of the real agent trajectories (126), real sensor data (128), real trajectory of the system capturing the real world (130), and real latencies (132) is data captured by or calculated directly from one or more sensors from the real world (e.g., in a real-world log). In other words, the data gathered from the real-world are actual events that happened in real life. For example, in the case that the autonomous system is a vehicle, the real-world data may be captured by a vehicle driving in the real world with sensor equipment.

Further, the data repository (105) includes functionality to store one or more scenario specifications (140). A scenario specification (140) specifies a scenario and evaluation setting for testing or training the autonomous system. For example, the scenario specification (140) may describe the initial state of the scene, such as the current state of the autonomous system (e.g., the full 6D pose, velocity and acceleration), the map information specifying the road layout, and the scene layout specifying the initial state of all the dynamic agents and objects in the scenario. The scenario specification may also include dynamic agent information describing how the dynamic agents in the scenario should evolve over time which are inputs to the agent models. The dynamic agent information may include route information for the agents, desired behaviors or aggressiveness. The scenario specification (140) may be specified by a user, programmatically generated using a domain-specification-language (DSL), procedurally generated with heuristics from a data-driven algorithm, or adversarial-based generated. The scenario specification (140) can also be conditioned on data collected from a real-world log, such as taking place on a specific real-world map or having a subset of agents defined by their original locations and trajectories.

The interfaces between the virtual driver and the simulator match the interfaces between the virtual driver and the autonomous system in the real world. For example, the sensor simulation model (114) and the virtual driver match the virtual driver interacting with the sensors in the real world. The virtual driver is the actual autonomy software that executes on the autonomous system. The simulated sensor data that is output by the sensor simulation model (114) may be in or converted to the exact message format that the virtual driver takes as input as if the virtual driver were in the real world, and the virtual driver can then run as a black box virtual driver with the simulated latencies incorporated for components that run sequentially. The virtual driver then outputs the exact same control representation that it uses to interface with the low-level controller on the real autonomous system. The autonomous system model (116) will then update the state of the autonomous system in the simulated environment. Thus, the various simulation models of the simulator (100) run in parallel asynchronously at their own frequencies to match the real-world setting.

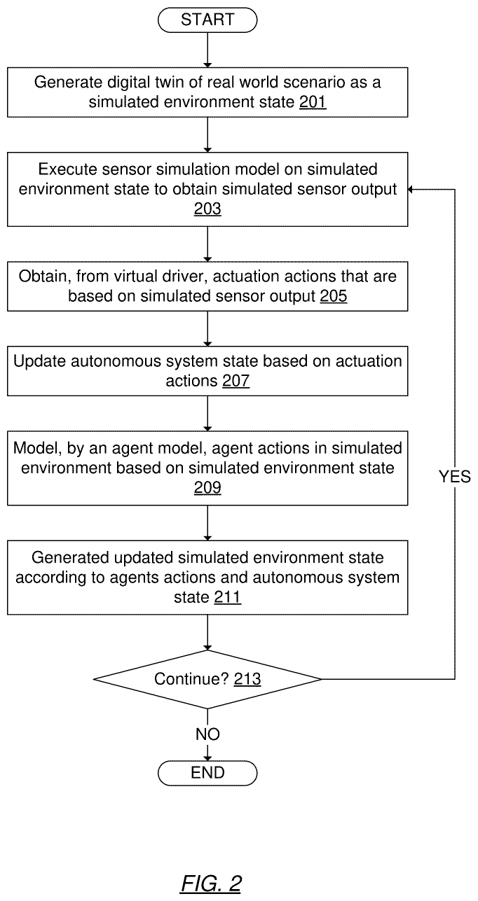

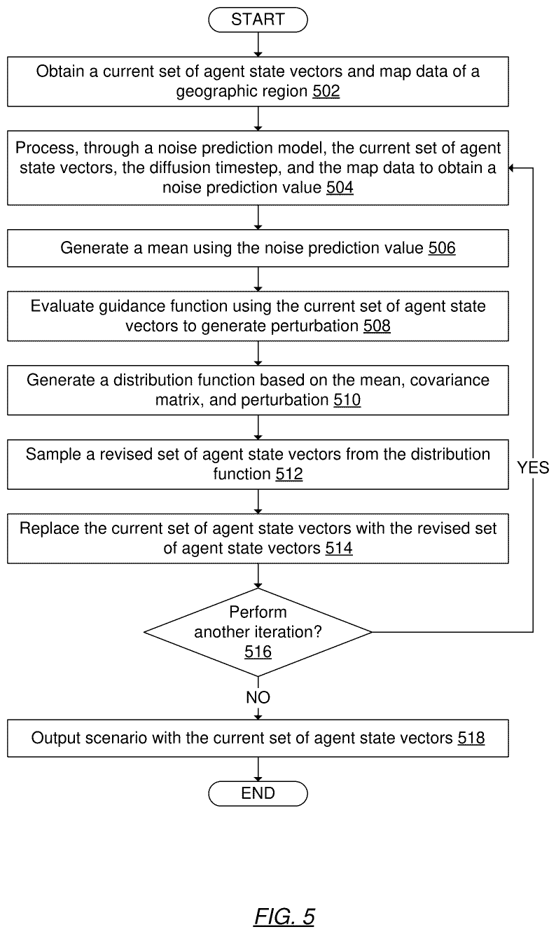

FIG. 2 shows a flow diagram for executing the simulator in one or more embodiments. In Block 201, an initial scene for a realistic scenario for the real world is generated as a simulated environment state. The initial scene may be generated by identifying a map of a geographic region. Log data from the real world may be used to generate an initial virtual world. The log data defines which asset models are used in the initial positioning of assets. Further, using the map of the geographic region and one or more constraints of agents, the training data generator may generate a set of agent states of agents in the initial scenes. As discussed above, the training data generator may generate a wide variety of sets of agent states, which each correspond to an individual execution of FIG. 2. The operations of the training data generator are described in FIG. 5.

Continuing with FIG. 2, in Block 203, the sensor simulation model is executed on the simulated environment state to obtain simulated sensor output. The sensor simulation model may use beamforming and other techniques to replicate the view to the sensors of the autonomous system. Each sensor of the autonomous system has a corresponding sensor simulation model and a corresponding system. The sensor simulation model executes based on the position of the sensor within the virtual environment and generates simulated sensor output. The simulated sensor output is in the same form as would be received from a real sensor by the virtual driver. In one or more embodiments, Block 203 may be performed as shown in FIGS. 4-6 (described below) to generate camera output and lidar sensor output, respectively, for a virtual camera and a virtual lidar sensor, respectively. The operations of FIGS. 4-6 may be performed for each camera and lidar sensor on the autonomous system to simulate the output of the corresponding camera and lidar sensor. Location and viewing direction of the sensor with respect to the autonomous vehicle may be used to replicate the originating location of the corresponding virtual sensor on the simulated autonomous system. Thus, the various sensor inputs to the virtual driver match the combination of inputs if the virtual driver were in the real world.

The simulated sensor output is passed to the virtual driver. In Block 205, the virtual drive executes based on the simulated sensor output to generate actuation actions. The actuation actions define how the virtual driver controls the autonomous system. For example, for a self-driving vehicle, the actuation actions may be the amount of acceleration, movement of the steering, triggering of a turn signal, etc. From the actuation actions, the autonomous system state in the simulated environment is updated in Block 207. The actuation actions are used as input to the autonomous system model to determine the actual actions of the autonomous system. For example, the autonomous system dynamic model may use the actuation actions in addition to road and weather conditions to represent the resulting movement of the autonomous system. For example, in a wet or snowy environment, the same amount of acceleration action as in a dry environment may cause less acceleration than in the dry environment. As another example, the autonomous system model may account for possibly faulty tires (e.g., tire slippage), mechanical based latency, or other possible imperfections in the autonomous system.

In Block 209, agents' actions in the simulated environment are modeled, by the agent, based on the simulated environment state. Concurrently with the virtual driver model, the agent model and asset models are executed on the simulated environment state to determine an update for each of the assets and agents in the simulated environment. Through the training of the agent model described in the following Figures, the agent model causes the agent to take actions that are more realistic. For some of the agents, the agents' actions may use the previous output of the evaluator to test the virtual driver. For example, if the agent is adversarial, the evaluator may indicate based on the previous action of the virtual driver, the lowest scoring metric of the virtual driver. Using a mapping of metrics to actions of the agent model, the agent model executes to exploit or test that particular metric.

Thus, in Block 211, the simulated environment state is updated according to the agents' actions and the autonomous system state to generate an updated simulated environment state. The updated simulated environment includes the change in positions of the agents and the autonomous system. Because the models execute independently of the real world, the update may reflect a deviation from the real world. Thus, the autonomous system is tested with new scenarios. In Block 213, a determination is made whether to continue. If the determination is made to continue, testing of the autonomous system continues using the updated simulated environment state in Block 203. At each iteration, during training, the evaluator provides feedback to the virtual driver. Thus, the parameters of the virtual driver are updated to improve the performance of the virtual driver in a variety of scenarios. During testing, the evaluator is able to test using a variety of scenarios and patterns including edge cases that may be safety critical. Thus, one or more embodiments improve the virtual driver and increase the safety of the virtual driver in the real world.

As shown, the virtual driver of the autonomous system acts based on the scenario and the current learned parameters of the virtual driver. The simulator obtains the actions of the autonomous system and provides a reaction in the simulated environment to the virtual driver of the autonomous system. The evaluator evaluates the performance of the virtual driver and creates scenarios based on the performance. The process may continue as the autonomous system operates in the simulated environment.

FIG. 3 shows a diagram of a scene generator (300) in accordance with one or more embodiments. The scene generator (300) is a more generic version of a training data generator described above in reference to FIG. 1. For example, whereas a training data generator has output that trains the virtual driver, the scene generator output may be used to train the virtual driver, may be used in placement of computer players in a gaming system, or may be used for other purposes. The components of the scene generator shown in FIG. 3 may be the same as the components of the training data generator.

As shown in FIG. 3, the scene generator includes a randomized agent state generator (302), a noise prediction model (304), a covariance matrix (306), a distribution function (308), an agent state sampler (310), and a guidance function (312). Each of these components is described below.

The randomized agent state generator (302) is configured to generate a randomized set of agent states. The set of agent states may have one or more agent states, whereby each agent has an individual corresponding agent state in the set. In one or more embodiments, an agent state is an initial set of attributes of the corresponding agent. For example, the agent state may include a position in the geographic region, a heading, a speed or acceleration, a size, and other initial set of attributes of the agent. The position may be a two- or three-dimensional position in the geographic region (e.g., specified as x, y coordinates or latitude longitudinal coordinates). The heading may be specified by an angle (e.g., from North), or using another direction. The size may be specified by a bounding box around the agent. Other mechanisms for specifying the various attributes of the agent may be used. In one or more embodiments, the agent state may be stored or represented using an agent state vector. For example, the attributes of the agent may be concatenated into the agent state vector.

The randomized agent state generator (302) is configured to generate random agent states. The randomized agent states may be completely random numbers. As another example, the randomized agent states may be constrained by a set of rules that define minimum and maximum boundaries on individual attributes of the agent. For example, the set of rules may be a broad set of rules that generally define ranges of possible attributes of the agent (e.g. the length and width of the agent must be greater than zero, the position of the agent needs to be somewhere in the geographic region defined by the map, etc.).

By way of nomenclature, the current set of agent states are the agent states for the current diffusion timestep. The revised set of agent states are revisions on the agent states and may be used for the next diffusion timestep. Both the current and revised set of agent states are an initial agent states that are to be the starting states of the agent in a simulation or game.

The noise prediction model (304) is a machine learning model that is trained to generate a noise prediction value for the current set of agent states. The noise prediction value is the amount of noise that corrupts the realistic agent states into the current set of agent states. In one or more embodiments, each agent has a corresponding noise prediction value generated by the noise prediction model for the agent. The noise prediction model (304) is described in more detail in FIG. 4.

The covariance matrix (306) has the covariance of the reverse distribution at each diffusion timestep. In one or more embodiments, the variance schedule is a fixed schedule of an amount of noise to inject at each timestep of the forward diffusion process. In one or more embodiments, the covariance matrix (306) is a diagonal matrix with scalar values that are proportional to the fixed noise schedule on the diagonal. The value of the diagonal of the matrix is the value of the variance schedule at that diffusion timestep. In one or more embodiments, all values on the diagonal share this same value. In the diagonal matrix, one row for every attribute and every agent exists. For example, suppose the agent states vector is 6-dimensional and there are 10 agents in the scenario. Then the covariance matrix is a 60×60 diagonal matrix. Thus, at each diffusion timestep, each agent's attribute is independently sampled. Each diffusion timestep may have a corresponding covariance matrix. While a diagonal matrix is presented, other implementations may be used for the covariance matrix. For example, the covariance matrix may be a non-diagonal matrix predicted by a neural network.

The distribution function (308) is a function on agent state vectors. The agent state vectors may be concatenated together into a combined agent state vector. The sets of possible combined agent state vectors may be defined by the distribution function. The distribution function (308) is defined by a mean that is parameterized by the noise prediction model (304) and a variance defined by the covariance matrix (306). In one or more embodiments, the distribution function (308) is a Gaussian distribution. For example, the distribution function (308) may be an isotropic Gaussian distribution.

The agent state sampler (310) is configured to sample the distribution function to obtain a revised set of agent states. Virtually any implementation of random sampling may be used. For example, the agent state sampler may use inverse transform sampling, Box-Muller transform, etc. In some implementations, because the distribution function is a Gaussian distribution, the sampling may be from a normal Gaussian distribution (with mean=0 and covariance matrix=identity) using the Box-Muller transform. Then the sample is scales and shifted the sample according to the predicted mean and the value of the variance schedule at that diffusion timestep. Regardless of whether the distribution function is adjusted or the sample is adjusted using the predicted mean, both techniques are considered to be included in generating the distribution function according to the mean.

In one or more embodiments, the guidance function (312) is a mathematical function that is differentiable and implements a constraint on agent state. The guidance function (312) is configured to calculate a perturbation of the mean based on the current agent state and a definition of a constraint. Further, the guidance function is configured to generate a perturbation for the mean when the current agent state does not satisfy the corresponding criteria. Thus, the guidance function is configured to nudge the agent state towards a value satisfying the corresponding criteria.

Different types of guidance functions exist. For example, guidance functions may be based on spatial regional constraints, speed, exact location/speed of agents (i.e., initial scene constraints), on-road constraints, and collision constraints. Below are how the various guidance functions may be implemented.

For spatial regional constraints, a user may specify a polygon of a region in space. For example, the polygon may be a two-dimensional polygon. The guidance function may use a signed distance function that calculates the signed distance of where the agent is in relation to the polygon. Under the guidance function, once the agent is in the polygon, the value of the guidance function is zero. If the agent is outside the polygon as determined by the guidance function, the signed distance is used to generate the perturbation. Because the guidance function is differentiable, the gradient of the guidance function with respect to the agent and the state may be used for the perturbation.

The agent attributes guidance function may operate similar to the spatial regional constraint guidance function. The attributes may be on a one-dimensional interval. If the attribute is within the interval, then the guidance function evaluates to zero. If the attribute is outside of the interval, then the guidance function evaluates to a non-zero value.

In one or more embodiments, the initial scene constraint perturbs selected agents to be identical to an initial state, which is not randomly generated. The guidance function may calculate an L2 distance between the current agent state of the agent and the initial agent state of the agent to obtain an intermediate result. The intermediate result may be multiplied by 1 if the agent is in the select set of agents or 0 if the agent is not in the select set of agents. The result is the value used to determine the amount of perturbation.

The guidance function may also implement common sense constraints. Common sense constraints may be that the agents do not start in a position of collision and that the agents start on-road. A guidance function implementing collision constraints may use circles so that the guidance function is differentiable. For example, the agent's location may be approximated by a set of circles in the case of two-dimensional inside the agents bounding box. For any pair of agents, the guidance function calculates the distance between the center of the two closest circles and divide by the sum of the radii of the two closest circle to obtain a result. If the agents are colliding, then the result is less than one and the guidance function is activated. If the agents are not colliding, then the result is less than one and the guidance function is not activated.

A guidance function implementing offroad constraints may calculate a distance between an agent and a centerline of nearest map element. If the distance is zero, the agent is on the centerline. If the distance is non-zero, the agent is not on the centerline. As discussed above, the guidance function adds a perturbation to the mean. When the evaluation of the guidance function with the current set of agent states results in a zero, then no perturbation is added. Further, the guidance function indicates the degree to which the current set of agent states satisfies the constraints and in which direction to perturb the agent states to satisfy the constraint.

FIG. 4 shows a diagram of the noise prediction model (400) in accordance with one or more embodiments of the invention. The noise prediction model (400) in FIG. 4 is an example of the noise prediction model (304) in FIG. 3. Other noise prediction models may be used without departing from the scope of the claims. The noise prediction model (400) is connected to a map data repository (402) and one or more agent states (404). The map data repository (408) is configured to store map data. Map data is data describing the map of the geographic region. The map data identifies types, positions, and other attributes of map elements in the geographic region. Map elements are physical portions of the geographical region that may be reflected in a map of the geographic region. For example, the map elements may be a curb, a particular lane marker, a particular location between two lane markers or a lane marker and a curb, a light, a stop sign, or a construction zone, or other physical object/location in the geographic region. The map elements may or may not be demarcated in the real world. For example, if the map element is a particular spot in the real world that is between two lane markers, the particular spot exists in the real world and has a physical location, but the particular spot may not have any signposts or other markings in the real world that are at the particular spot. In one or more embodiments, a map of the geographic region directly or indirectly specifies the stationary locations of the map elements.

The agent states (404) are the current set of agent states of the agents. The agent states are the states described above with reference to FIG. 3.

The noise prediction model (400) may include a map encoder model (408), an agent encoder model (410), a transformer model (414), and a decoder model (416) in accordance with one or more embodiments.

The map encoder model (408) is a software process configured to encode map elements of a geographic region as relative positions with respect to each other. Specifically, the map encoder model (408) may be configured to calculate, for each map element, the relative position of the map element with respect to other map elements in the geographic region. Thus, for each map element, a set of relative positions of the map element with respect to other map elements may be defined. The map encoder model (408) may be further configured to encode the relative positions into a feature set for a pair of map elements. Additionally, a map element may have a feature set defining the map element. For example, the feature set may encode size information, the type of geographic region in which the map element is located (e.g., urban, rural, etc.), type of map element, and other features about the map element or the properties surrounding the map element.

The output of the map encoder model (408) may be map element encodings in a map layer a graph. The map layer is a graph data structure having a map element nodes connected by edges. The map element node is for an individual corresponding map element. The edges connecting two map element nodes may be associated with a relative position encoding of the corresponding pair of map element nodes. The map element node may be associated with a feature set that is generated based on general features of the map element. Prior to outputting, the map encoder model (410) may include a graph neural network that is configured to process the feature sets of the map element nodes based on connected feature sets to obtain an updated feature set for each map element node.

The agent encoder model (410) may be configured to generate feature set for each agent state. For example, the agent encoder model may be a multilayer perceptron model that takes, as input, the agent state vector of an agent and produces, as output, a feature set for the agent.

The transformer model (414) is a machine learning model that includes self-attention and cross attention layers. The self-attention layers have the feature sets of agents attending to themselves and the cross-attention layers are between the feature sets of agents and the feature sets of the map element nodes. The cross attention may be between each agent and the agent's K nearest map elements (e.g., measured by L2 distance). For example, K may be four or another value. Cross-attention may also be performed each agent to all map elements. The transformer model may have several layers of self-attention and cross attention layers.

The decoder model (416) is configured to decode the resulting feature sets of each agent and generate a noise prediction value. A single noise prediction value may be generated for all agents, or an individual noise prediction value may be generated for each agent. For example, the decoder model may be a multilayer perceptron model.

The training of the noise prediction model may be performed using the forward diffusion process. For example, a set of real-world or user defined agent states may be used as input to the forward diffusion process. Over the course of the diffusion timesteps in the forward direction, noise is injected into the agent states to corrupt the agent states. The amount of noise injected at each stage of the forward diffusion process is recorded. The final corrupt set of agent states are used as input to the reverse diffusion process. In the reverse diffusion process, the noise prediction model predicts the noise that is injected in the corresponding steps forward diffusion process. In an example, if the forward diffusion process has five hundred timesteps, each with a corresponding injected noise value for the step, then the noise prediction model generates, in reverse direction, a predicted noise value in the reverse diffusion process for the five hundred timesteps. An L2 loss may be calculated between the injected noise value and the predicted noise value.

In another example, the number of timesteps in the reverse direction may be less than the number of timesteps in the reverse direction to make training faster. The L2 loss may be an approximation of the L2 loss that would be generated using the same number of timesteps. In the previous example, instead of predicting a noise value for all five hundred timesteps, the following operations may be performed: (1) sample a diffusion timestep (e.g., t=251); (2) corrupt the real data into the noisy data for t=251, which can be done with a closed-form formula; and (3) predict the noise used to corrupt the real data to the noisy data at t=251. Then, the computing system computes an L2 loss between the predicted noise and the actual noise. In the process using fewer timesteps in the reverse direction, the L2 loss is a Monte Carlo approximation of the actual L2 loss if the same number of timesteps in the forward and reverse direction were used. Having a reduced number of timesteps in the reverse direction is computationally more efficient.

The L2 loss may be backpropagated through the noise prediction model to update the noise prediction model. By iteratively updating the noise prediction model to be more accurate, the noise prediction model is better able to predict the noise that caused realistic agent states to be transformed into corrupt agent states. By having better prediction of the noise, the noise may be backed out of the corrupt agent states to generate more realistic agent states.

FIG. 5 shows a flowchart for diffusion for realistic scene generation in accordance with one or more embodiments of the invention. The realistic scene generation may be initiated by a user. For example, in some embodiments, a user specifies an initial set of parameters of initial scenes. The parameters may be broadly defined, such as just specifying the geographic region, and optionally the number of agents to place in the geographic region. In other cases, the user may specify constraints on the agent attributes. The constraints may include a polygon specifying a location in the geographic region to place agents, attributes of the agent (e.g., speed or size attributes) or other parameters. As another example, the user may start with a real-world or previously generated scene and specify that certain agents in the scene should have fixed attributes initially. Namely, such agents should have the same set of attributes at the start of the scene as in the real world or the previously generated scene. The user may also specify constraints for the addition of remaining agents. The user has control on the level of granularity to design the scene. For example, as discussed above, the user may simply request that millions of scenes are generated and not specify a map (i.e., the computing system may randomly select a geographic region), or the user may specify number and ranges of speeds of agents. Notably, the parameters that the user does not specify are not default attributes in one or more embodiments, but rather generated through the diffusion process to be realistic as described in FIG. 5. Thus, the computing system is effectively able to self-train a virtual driver using thousands of diverse and realistic scenarios.

In Block 502, a current set of agent state vectors and map data of a geographic region is obtained. For the agents, the corresponding agent state vectors may be randomly generated. Fixed agents may also have agent state vectors randomly generated and then nudged to the fixed states. For example, the random sampling may be performed using an isotropic Gaussian distribution The number of remaining agents may be randomly defined. For example, a random number generator may be used to randomly initialize each agent state vector. In some embodiments, the random generation is, for each of at least a subset of attributes, to randomly generate the attribute value within a range of possible values. Further, a map of the geographic region is obtained. The map may be randomly selected from various maps of the geographic region. As another example, a map of a prespecified geographic region may be obtained. The initial agent state vectors form the current set of agent state vectors, whereby an individual agent state vector may exist for each agent.

In Block 504, through a noise prediction model, the current set of agent state vectors, the diffusion timestep, and the map data are processed to obtain a noise prediction value. The map may be a high-definition lane graph map. Map element nodes for map elements defined in map data may be obtained. The map element nodes may be connected by edges based on relative positions between the of map elements. Further, the map element nodes may have features based on attributes of the corresponding map elements. For example, the attributes may be position of the map element in the region, speed limit, type of geographic region, type of map element and other attributes. The result of the map element nodes connected by edges is a graph. The graph may be processed through a graph neural network to encode the attributes into features for the respective map element nodes. Through various layers of the graph neural network, the features of a particular map element node may be adjusted to reflect the features of the nearby map element nodes.

Further, in one or more embodiments, the current set of agent state vectors are encoded through a first set of neural networks layers to generate a set of agent state vector encodings. Each agent state vector has a corresponding agent state vector encoding generated for the agent using the first set of neural network layers. The set of agent state vector encodings are processed through one or more self-attention layers to obtain first updated set of agent state vector encodings. The first updated set of agent state vector encodings may then be processed through one or more cross attention layers with the features of respective map element nodes to obtain second updated set of agent state vector encodings. The self-attention and cross attention may be performed multiple times to generate second updated set of agent state vector encodings. After processing through the various attention layers, the second updated set of agent state vector encodings are processed through a second set of neural network layers to generate the noise prediction value. For example, the second set of neural networks layers may be a multilayer perceptron model of a decoder model. The result of processing may be a noise prediction value. In one or more embodiments, each agent has a corresponding noise prediction value generated for the agent.

In Block 506, a mean is generated using the noise prediction value. In one or more embodiments, the noise prediction value is a parameter to a function that is used to calculate the mean. By evaluating the function, a mean is generated.

In Block 508, a guidance function is evaluated using the current set of agent state vectors to generate perturbation. The guidance function is a differentiable function that is dependent on the type of constraints in one or more embodiments. If the corresponding agent state vector satisfies the constraint, the guidance function evaluates to zero. If the corresponding agent state vector does not satisfy the constraint, the guidance function evaluating using the corresponding agent state value evaluates to a non-zero value. The magnitude of the value evaluated from the guidance function is dependent on the degree to which the constraint is not satisfied. Evaluating the guidance function is performed by the computer system evaluating the mathematical function.

Below are some examples of evaluating the guidance function. The guidance function generates a non-zero perturbation for the perturbation when an agent state vector in the current set of agent state vectors indicates that an agent attribute of the agent satisfies a constraint, whereby the agent attribute is a speed or a bounding box size of the agent. As another example, the guidance function may generate a non-zero perturbation for the perturbation when an agent state vector in the current set of agent state vectors includes a value deviating from an initial fixed value in an initial set of agent state vectors. As another example, the guidance function generates a non-zero perturbation for the perturbation when an agent state vector in the current set of agent state vectors includes an agent position that deviates from a lane in a map of the geographic region or collides with another agent in the geographic region. Many different types of guidance functions may be used.

In Block 510, a distribution function is generated based on the mean, covariance matrix, and perturbation. In one or more embodiments, the distribution function is defined by the mean and the variance. The variance is defined by a fixed covariance matrix, which is different for each of the diffusion timesteps. Namely, each diffusion timestep may have a predetermined covariance matrix that is set by a forward diffusion process that is used to train the noise prediction model.

The mean may be modified by the perturbation value evaluated by the guidance function. The perturbation value is used to revise the mean. For example, the gradient of the guidance function as determined by the perturbation may be used to revise the mean. Thus, if the guidance function is used, the mean may be increased or decreased by the amount defined by the perturbation.

Generating the distribution function based on the mean, covariance matrix, and perturbation includes creating a new distribution function from the mean, covariance matrix, and perturbation or sampling from a predefined distribution function (e.g., with a mean of zero and an identity matrix for the covariance matrix) to generate a sample, which is altered using the mean, perturbation value, and covariance matrix.

Conceptually, a single distribution function may be used for all agents. The single distribution function may generate independent samples for each agent. Thus, each agent has an independent distribution for the agent because the covariance matrix is a diagonal matrix. If the covariance matrix were non-diagonal, then the distribution function is for all agents.

In Block 512, a revised set of agent state vectors is sampled from the distribution function. A sampling algorithm samples from the distribution function to obtain a revised set of agent state vectors. Through the reverse diffusion process, the revised set of agent state vectors generally has less noise than the current set of agent state vectors.

In Block 514, the current set of agent state vectors is replaced with the revised set of agent state vectors. Thus, the current set of agent state become the revised set of agent state vectors.

In Block 516, a determination is made whether to perform another iteration. Specifically, a determination is made whether to perform another diffusion timestep. In one or more embodiments, a predetermined number of diffusion timesteps is performed. Thus, the determination to perform another iteration may be based on whether the number of iterations is equal to the predetermined number of diffusion timesteps. If the number of iterations is not equal to the predetermined number of diffusion timesteps, the process repeats with Block 504. If the number of iterations is equal to the predetermined number of diffusion timesteps, the process may proceed to Block 518.

In Block 518, a scenario with the current set of agent state vectors is outputted. The initial scene has the agent states defined by the current set of agent state vectors. The initial scene is used to populate the geographic region with agents. Using the initial scene, the virtual driver of an autonomous system may be trained using the current set of agent state values. For example, the process of FIG. 2 may be performed with the initial scene as the start of the scenario. Thus, one or more embodiments provide a technique for the computing system to generate its own training data that is used to perform its own training. When the virtual driver satisfies a threshold level of performance, the autonomous system with the virtual driver may be deployed in the real world.

In one or more embodiments, in the operations of FIG. 5, the agents are considered and processed as a group. In the noise prediction model that predicts the mean of the distribution function in the reverse diffusion process, the transformer model extracts per-agent features based on the features of all agents in the scene. Similarly, the guidance function may be a function of all agents in the scene so that various constraint values may be computed (e.g., whether a collision exists between two agents).

As discussed above, the noise prediction model is used to parameterize the mean of the distribution model that is sampled. The noise prediction model may be trained using the following operations. Real-world locations of agents may be processed through a forward diffusion process to generate a training set of actual noise values and a set of randomized agent states. Using the noise prediction model, the set of randomized agent states may be processed through a reverse diffusion process to generate a training set of predicted noise values. A loss is generated based on a difference between the training set of actual noise values and the training set of predicted noise values. The loss may be backpropagated through the noise prediction model to update the noise prediction model.

The following description are for explanatory purposes only and not intended to limit the scope of the claims. Specifically, the example below is an example implementation that may be used. Embodiments of the invention may depart from the example implementation without departing from the scope of the claims. In the following example consider the scenario in which the agents are vehicles driving on roadways.

The following notation may be used. One or more embodiments may parameterize a traffic scene with n agents by the joint agent states s_{1:n}={s₁, . . . , sₙ} and a high definition (HD) map m of the region of interest, which provides contextual information about the surrounding road topology. The number of agents n varies between scenes. The following description focuses on a setting where n is given (e.g., where users specify the desired density of the scene). In some embodiments, the number of agents may be randomly generated. Each agent state sᵢ ∈R⁶ is represented by the agent's centroid location (xᵢ,yᵢ)∈ [symbol] ², bounding box length and width (lᵢ, wᵢ)∈ [symbol] ₊² heading angle θᵢ∈[0,2π), and speed δᵢ∈ [symbol] _{≥0}. The HD map may be represented as a lane graph G=(V,E), where each vertex u∈V is a lane segment and an edge (u, v)∈E indicates that v is a successor, predecessor, or left/right neighbour of u.

First, one or more embodiments may learn a generative model of traffic scenes p_{φ}(s_{1:n}|m) to capture the distribution of real-world traffic scenes. Then, during inference, one or more embodiments may sample from a perturbed distribution,

$${\tilde{p}}_{φ} ( {s}_{1 : n} \vert m ) ∝ {p}_{φ} ( {s}_{1 : n} \vert m ) g ( {s}_{1 : n} , m ) \qquad ( 1 )$$

where g is a guidance function that encodes the degree to which a scene s_{1:n} satisfies some high-level constraints. Sampling from the perturbed distribution corresponds to generating scenes that may be realistic under p_{φ}(s_{1:n}|m) and constraint-satisfying under g(s_{1:n}, m). By varying the guidance function, one or more embodiments may can flexibly encode different constraints into the generation process. For example, using the identity recovers unconditional scene generation whereas using a collision cost encourages collision-free scenes instead. The formulation decouples realism from controllability, allowing reuse of the same model with various implementations of g without re-training.

p_{φ}(s_{1:n}|m) is parameterized with a diffusion model. The diffusion model is described below along with how to sample from \tilde{p}(s_{1:n}, m).

A diffusion model is a latent variable model that learns to reverse a forward diffusion process. For notational brevity, let x₀=(s₁ . . . sₙ)∈ [symbol] ^{n×6} denote n states s_{1:n}.

Starting from data x₀˜q(x₀), the forward diffusion process q(xₜ|xₜ₋₁) gradually corrupts the clean agent states x₀ with Gaussian noise over T steps according to a variance schedule β₁, . . . , β_{T},

$$q ( {x}_{t} \vert {x}_{t - 1} ) = 𝒩 ( \sqrt{{β}_{t}} {x}_{t - 1} , ( 1 - {β}_{t} ) I ) \qquad ( 2 )$$

The forward diffusion process yields a chain of noisy agent states x₁, . . . , x_{T}.

For reverse diffusion process, given a sufficiently large T and suitable variance schedule, the distribution of x_{T} may be approximated by an isotropic Gaussian [symbol] (0, I). If the reverse distribution q(xₜ₋₁|xₜ) is known, a sample x₀˜q(x₀) is generated by sampling x_{T}˜ [symbol] (0, I) and reversing the forward process. The reverse distribution q(xₜ₋₁|xₜ) is approximated. Because the sampling is from the conditional distribution p(s_{1:n}|m), reversing the forward process is conditional on the HD map m,

$${p}_{φ} ( {x}_{t - 1} \vert {x}_{t} , m ) = 𝒩 ( {μ}_{φ} ( {x}_{t} , t , m ) , {Σ}_{φ} ( {x}_{t} , m , t ) ) \qquad ( 3 )$$

where μ_{φ}(xₜ, t, m) and Σ_{φ}(xₜ, t, m) is the approximate mean and covariance of the reverse distribution at each step t, φ is a learnable parameter. Then, to sample a scene x₀˜p_{φ}(x₀|m), one or more embodiments may reverse the forward process, using p_{φ}(xₜ₋₁|xₜ, m) in place of q(xₜ₋₁|xₜ) at each step t.

One or more embodiments may fix Σ_{φ}(xₜ, t, m)=βₜI and parameterize the approximate mean as

$${μ}_{φ} ( {x}_{t} , t , m ) = \frac{1}{\sqrt{{α}_{t}}} ( {x}_{t} - \frac{{β}_{t}}{\sqrt{1 - {\overline{α}}_{t}}} {ϵ}_{φ} ( {x}_{t} , t , m ) ) \qquad ( 4 )$$

where αₜ=1−βₜ and α̅ₜ=Πⱼ₌₁^{t} αⱼ, wherein j is an index variable to count over the diffusion timestep. Intuitively, ∈_{φ}(xₜ, t, m) predicts the noise ∈ that corrupts x₀ into xₜ=\sqrt{αₜ}x₀+\sqrt{1−α̅ₜ}∈. Therefore, learning a diffusion model amounts to learning a noise prediction model ∈_{φ}(xₜ, t, m) to de-noise xₜ into a sample of the data x₀˜p_{φ}(x₀).

The noise prediction model ∈_{φ}(xₜ, t, m) may be as a transformer-based architecture with a lane graph neural network (GNN) to model complex agent-to-agent and agent-to-map interactions. The example implementation has a diffusion model that directly operates over the vector representation of the agent states and the lane graph. Thus, the architecture is lightweight, permutation-equivariant, and manages a variable number of agents. The noise prediction model may include (1) a set of encoders to featurize the input states and map; (2) a transformer decoder to model interactions; and (3) a decoder to predict the diffusion noise.

Given noisy agent states xₜ∈ [symbol] ^{n×6} and an HD map m, one or more embodiments may encode each state vector with a multi-layer perceptron (MLP) and encode lane graph representation of m using a lane graph GNN. One or more embodiments may also embed the diffusion timestep t with sinusoidal positional encoding and an MLP.

$${h}_{s}^{0} = MLP ( {x}_{t} ) , {h}_{m} = GNN ( m ) , {h}_{t} = MLP ( PE ( t ) ) \qquad ( 5 )$$

Next, one or more embodiments may use a series of interleaving self-attention and cross-attention layers to fuse the agent features hₛ⁰ and lane graph features hₘ. Here, self-attention uses agent state features hₛ^{k} as queries, keys, and values, allowing the noise prediction model to extract agent-to-agent interactions. To condition on m, cross-attention instead uses lane graph features hₘ as the keys and values, allowing the noise prediction model to capture agent-to-map interactions. After each pair of attention layers, one or more embodiments may fuse the diffusion timestep embedding hₜ into the resulting features:

$${h}_{s}^{k + 1} + Cross Attn ( Self Attn ( {h}_{s}^{k} ) , {h}_{m} ) + {h}_{t} \qquad ( 6 )$$

After K blocks of self-attention and cross-attention, one or more embodiments may use an MLP to predict the forward diffusion noise:

$${ϵ}_{φ} ( {x}_{t} , t , m ) = MLP ( {h}_{s}^{K} ) \qquad ( 7 )$$

For training, one or more embodiments may learn the noise prediction model ∈_{φ}(xₜ, t, m) using noise-matching:

$$L ( θ ) = {𝔼}_{{x}_{0} , m , t , ϵ} [ {‖ ϵ - {ϵ}_{φ} ( {x}_{t} , t , m ) ‖}^{2} ] \qquad ( 8 )$$

where x₀ and m is the joint agent states and HD map for a real traffic scene, t˜Uniform(1, T) is a diffusion step, and xₜ is the agent states x₀ corrupted with noise ∈˜ [symbol] (0,I).

Turning to the sampling of the generative model p_{φ}(s_{1:n}|m), the perturbed distribution \tilde{p}_{φ}(s_{1:n}|m)∝p_{φ}(s_{1:n}|m)g(s_{1:n}, m) is sampled to generate scenes that satisfy high-level constraints. For diffusion models, one or more embodiments may use guided sampling. Given the number of agents n (e.g., specifying the desired scene density), one or more embodiments may first sample n random noise vectors, which one or more embodiments may denote x_{T}˜ [symbol] (0, I). Then, at each step t of reverse diffusion, rather than sampling from p_{φ}(xₜ₋₁|xₜ, m)= [symbol] (μ_{φ}(xₜ, t, m), βₜI), one or more embodiments may sample from:

$$𝒩 ( {μ}_{φ} ( {x}_{t} , t , m ) - {γ}_{t} {β}_{t} {∇}_{{x}_{t}} g ( {x}_{t} , m ) , {β}_{t} I ) \qquad ( 9 )$$

where γₜ is a time-varying coefficient that controls the guidance strength. Notably, this approach may not use re-training a new model for each guidance function, allowing for flexibly incorporating any constraints into scene generation.

The following are examples of guidance functions to incorporate constraints. For spatial region constraints, agents may be inserted into specific regions of interest in a scene (e.g., to manually populate specific areas around the autonomous system or automatically densify intersections). The following guidance function uses the signed distance function (SDF) of an agent's centroid (xᵢ, yᵢ) to the boundary of a 2D polygon c_{region}:

$${g}_{region} ( {s}_{i} , {c}_{region} ) = max \{ 0 , SDF ( {c}_{region} , ( {x}_{i} , {y}_{i} ) ) \} \qquad ( 10 )$$

Agent attributes constraint support allows for constraining agent attributes such as speed, bounding box size, etc. Unlike manually specifying each attribute, which can lead to unrealistic scenes (e.g., a truck with Ferrari speed at a tight turn), attributes are adapted for when controlling for a subset of them. To this end, the following guidance function uses the distance of an agent's attribute aᵢ to the boundary of a one-dimensional range cₐₜₜᵣ=(cₘᵢₙ, cₘₐₓ),

$${g}_{attr} ( {s}_{i} , {c}_{attr} ) = max \{ 0 , {a}_{i} - {c}_{max} , {c}_{min} - {a}_{i} \} \qquad ( 11 )$$

For initial scene constraints, traffic scenes may be generated from an empty map or from a scene with existing agents cᵢₙᵢₜ={ŝᵢ|i∈ [symbol] }. To generate for a scene with existing agents, the following guidance function penalizes the difference between the existing agents' sampled states versus original states:

$${g}_{init} ( {s}_{i} , {c}_{init} ) = 1 [ i ∈ 𝒥 ] ‖ {s}_{i} - {\hat{s}}_{i} ‖ \qquad ( 12 )$$

By adjusting the guidance strength, one or more embodiments may can interpolate between keeping the initial scene fixed versus allowing for adjustments that improve realism (e.g., moving existing agents closer together when densifying an already dense scene).

Common sense constraints may also be implemented by a guidance function. For example, collisions are rare, and agents generally drive on lanes. Common scene guidance functions penalize collisions and off-lane driving. For collision, one or more embodiments may use a differentiable relaxation. Each agent's bounding box may be approximated with five circles and compute the L2 distance d((xᵢ, yᵢ), (xⱼ, yⱼ)) between the centroids of the closest circles between the pair of agents (e.g., with radii rᵢ and rⱼ) as follows:

$${g}_{collision} ( {s}_{i} , {s}_{j} ) = max \{ 0 , 1 - \frac{d ( ( {x}_{i} , {y}_{i} ) , ( {x}_{j} , {y}_{j} ) )}{{r}_{i} + {r}_{j}} \} \qquad ( 13 )$$

For off-lane driving, the guidance function may use the minimum projection distance between an agent's centroid and its closest lane as follows:

$${g}_{lane} ( {s}_{i} , m ) = {min}_{lane ∈ m} {d}_{proj} ( ( {x}_{i} , {y}_{i} ) , lane ) \qquad ( 14 )$$

Beyond generating traffic scenes from scratch, one or more embodiments may also generate scenes that satisfy high-level constraints (e.g., where the agent is placed, how fast the agent drives, how large the agent is, etc.). Embodiments have guidance function that allow for the high-level constraints to achieve controllability, diversity, and realism.

Embodiments create an expressive diffusion model of traffic scenes that enables generation of realistic traffic scenes that satisfy arbitrary constraints. The diffusion model allows for flexible control the generation process to create traffic scenes at scale that exhibit desired characteristics, creating opportunities to improve how one or more embodiments may design scenarios for training and testing autonomy, making the safety case, and beyond.

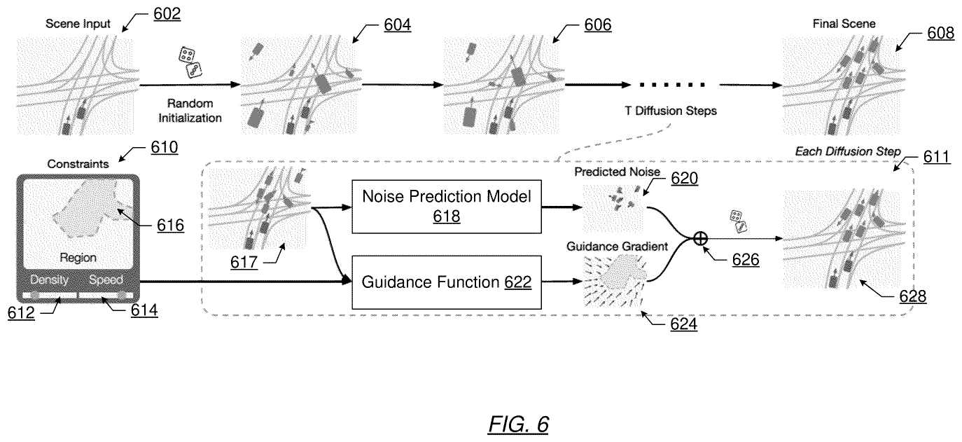

FIG. 6 shows a diagram for sampling from a diffusion model and controlling the sampling process to satisfy a set of constraints. The scene input (602) is the initial lane map with fixed agents. As shown in Block 604, an initial set of agent vectors are generated. The initial set of agent vectors are randomly generated to have random positions, headings and sizes of the agents in the geographic region. Over the period of T diffusion timesteps as demonstrated in Blocks 606 to 608, the process refines the agent vectors so that agents are placed in similar positions to how the agents may be in the real-world. Thus, the diffusion model is able to take a randomly generated set of agent states and generate a realistic set of agent states.

FIG. 6 also shows an example for incorporating constraints (610) in the diffusion model (618) at each diffusion timestep (611). For example, the constraints (610) may include density (612) and speed (614) of agents or a subregion (616) of the geographic region in which to place agents.

At each diffusion timestep, the noise prediction model (618) uses a current set of agent state vectors (617) to generate predicted noise (620). The guidance function (622) uses the constraints (610) with the current set of agent state vectors (617) to generate a guidance gradient (624). The guidance gradient (624) and the predicted noise (620) are combined (626) to generate a distribution from which a revised set of agent state vectors (628) are generated. By operating the diffusion model over tens of thousands of initial vectors, realistic training data can be generated to train the virtual driver. Further, by incorporating constraints, a user may guide how the virtual driver is trained without explicitly defining the thousands of starting states of agents in the scenarios.

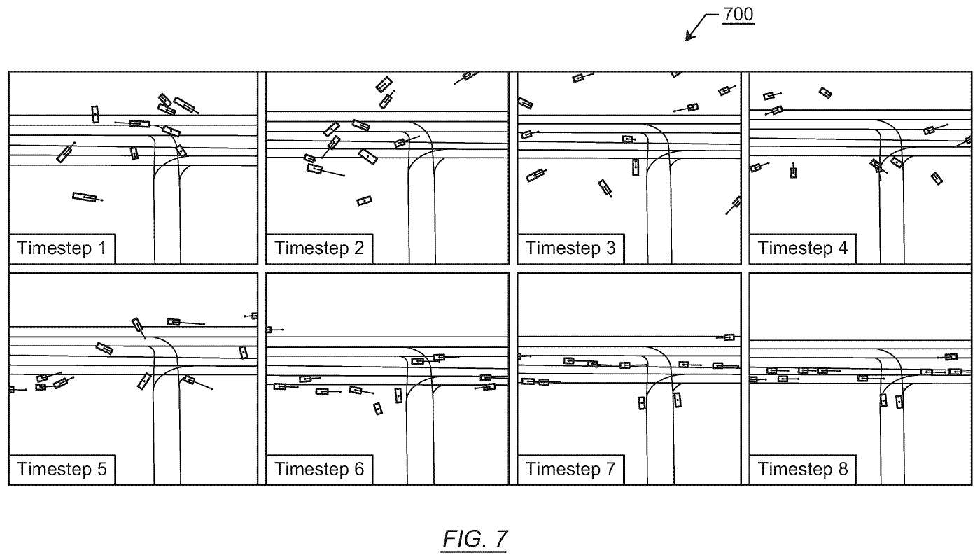

FIG. 7 shows an example of a diffusion process (700) without constraints in accordance with one or more embodiments. The visualizations in FIG. 7 are purely for descriptive purposes only. The diffusion process in one or more embodiments operates on vectors and not the shown images. In the example, eight diffusion timesteps ordered between 1-8 are shown. Between the shown adjacent diffusion timesteps are several additional diffusion timesteps that are not shown. For example, a total of five hundred diffusion timesteps may exist, of which only eight are shown. As shown in FIG. 7, the reverse diffusion process gradually changes the noisy random placement of agents in timestep 1 into a realistic placement of agents in timestep 8.

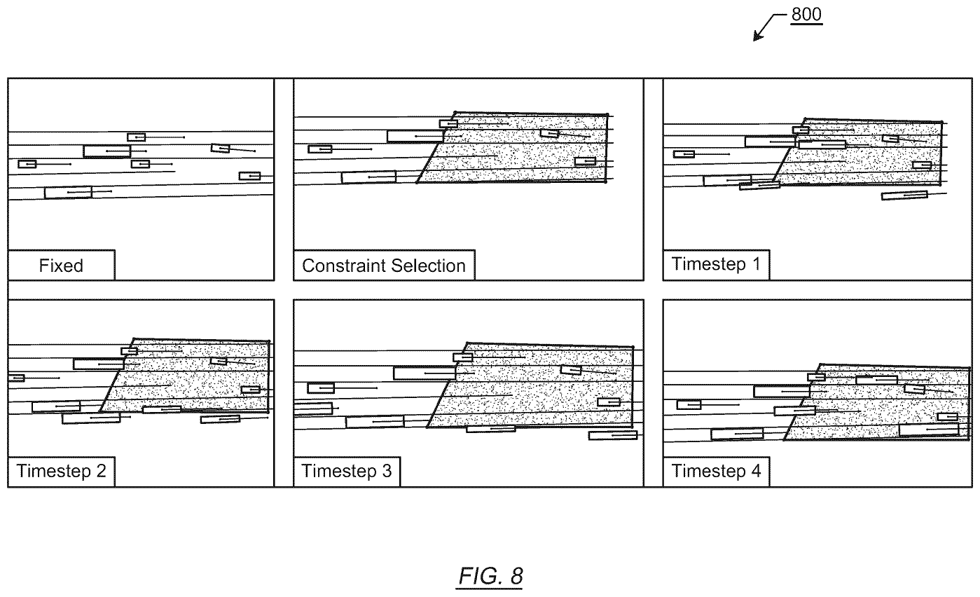

FIG. 8 shows another example of a diffusion process (800) with constraints and using a guidance function. The first image shows the fixed agents and map. The user may then select constraints including size of agents, speed, number of agents, and region. Over the series of diffusion timesteps of which only four are shown, the initial noisy placement of agents in timestep 1 is gradually moved to a realistic placement that satisfies the constraints in timestep 4.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 7A, the computing system (700) may include one or more computer processors (702), non-persistent storage (704), persistent storage (706), a communication interface (712) (e.g., Bluetooth interface, infrared interface, network interface, optical interface, etc.), and numerous other elements and functionalities that implement the features and elements of the disclosure. The computer processor(s) (702) may be an integrated circuit for processing instructions. The computer processor(s) may be one or more cores or micro-cores of a processor. The computer processor(s) (702) includes one or more processors. The one or more processors may include a central processing unit (CPU), a graphics processing unit (GPU), a tensor processing unit (TPU), combinations thereof, etc.

The input devices (710) may include a touchscreen, keyboard, mouse, microphone, touchpad, electronic pen, or any other type of input device. The input devices (710) may receive inputs from a user that are responsive to data and messages presented by the output devices (708). The inputs may include text input, audio input, video input, etc., which may be processed and transmitted by the computing system (700) in accordance with the disclosure. The communication interface (712) may include an integrated circuit for connecting the computing system (700) to a network (not shown) (e.g., a local area network (LAN), a wide area network (WAN) such as the Internet, mobile network, or any other type of network) and/or to another device, such as another computing device.

Further, the output devices (708) may include a display device, a printer, external storage, or any other output device. One or more of the output devices may be the same or different from the input device(s). The input and output device(s) may be locally or remotely connected to the computer processor(s) (702). Many different types of computing systems exist, and the aforementioned input and output device(s) may take other forms. The output devices (708) may display data and messages that are transmitted and received by the computing system (700). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (700) in FIG. 7A may be connected to or be a part of a network. For example, as shown in FIG. 7B, the network (720) may include multiple nodes (e.g., node X (722), node Y (724)). Each node may correspond to a computing system, such as the computing system shown in FIG. 7A, or a group of nodes combined may correspond to the computing system shown in FIG. 7A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (700) may be located at a remote location and connected to the other elements over a network.

The nodes (e.g., node X (722), node Y (724)) in the network (720) may be configured to provide services for a client device (726), including receiving requests and transmitting responses to the client device (726). For example, the nodes may be part of a cloud computing system. The client device (726) may be a computing system, such as the computing system shown in FIG. 7A. Further, the client device (726) may include and/or perform all or a portion of one or more embodiments.

The computing system of FIG. 7A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a current set of agent state vectors and a map data of a geographic region;
iteratively, through a plurality of diffusion timesteps, updating the current set of agent state vectors, wherein iteratively updating comprises:
processing, by a noise prediction model, the current set of agent state vectors, a current diffusion timestep of the plurality of diffusion timesteps, and the map data to obtain a noise prediction value,
generating a mean using the noise prediction value,
generating a distribution function according to the mean,
sampling a revised set of agent state vectors from the distribution function, and
replacing the current set of agent state vectors with the revised set of agent state vectors; and
outputting the current set of agent state vectors.

2. The method of claim 1, further comprising:
evaluating a guidance function using the current set of agent state vectors to generate a perturbation; and
revising the mean according to the perturbation.

3. The method of claim 2, wherein revising the mean according to the perturbation comprises using a gradient of the guidance function.

4. The method of claim 2, further comprising:
generating, by the guidance function, a non-zero perturbation for the perturbation when an agent state vector in the current set of agent state vectors indicates that a position of an agent is outside of a subregion of the geographic region.

5. The method of claim 2, further comprising:
generating, by the guidance function, a non-zero perturbation for the perturbation when an agent state vector in the current set of agent state vectors indicates that an agent attribute of an agent satisfies a constraint.

6. The method of claim 5, wherein the agent attribute is at least one selected from a group consisting of a speed and a bounding box size of an agent.

7. The method of claim 2, further comprising:
generating, by the guidance function, a non-zero perturbation for the perturbation when an agent state vector in the current set of agent state vectors comprises a value deviating from an initial fixed value in an initial set of agent state vectors.

8. The method of claim 2, further comprising:
generating, by the guidance function, a non-zero perturbation for the perturbation when an agent state vector in the current set of agent state vectors comprises an agent position performing one of deviating from a lane in a map of the geographic region and colliding with another agent in the geographic region.

9. The method of 1, further comprising:
generating the distribution function using a fixed covariance matrix, wherein the fixed covariance matrix is different for each of the plurality of diffusion timesteps.

10. The method of claim 1, further comprising:
randomly initializing the current set of agent state vectors.

11. The method of claim 1, further comprising:
generating a plurality of map element nodes for a plurality of map elements defined in map data, the plurality of map element nodes connected by a first plurality of edges based on relative positions between the plurality of map elements;
encoding the current set of agent state vectors through a first set of neural networks layers to generate a set of agent state vector encodings;
processing the set of agent state vector encodings through a self-attention layer to obtain first updated set of agent state vector encodings;
processing the first updated set of agent state vector encodings through a cross attention layer with the plurality of map element nodes to obtain second updated set of agent state vector encodings; and
processing the second updated set of agent state vector encodings through a second set of neural network layers to generate the noise prediction value.

12. The method of claim 11, wherein processing the first set of agent state vector encodings and processing the first updated set of agent state vector encodings is performed iteratively over a predefined number of iterations.

13. The method of claim 1, further comprising:
processing a plurality of real-world locations through a forward diffusion process to generate a training set of actual noise values and a set of randomized agent states;
processing, using the noise prediction model, the set of randomized agent states through a reverse diffusion process to generate a training set of predicted noise values;
generating a loss based on a difference between the training set of actual noise values and the training set of predicted noise values; and
backpropagating the loss through the noise prediction model.

14. The method of claim 1, further comprising:
training a virtual driver of an autonomous vehicle using the current set of agent state values.

15. The method of claim 14, further comprising:
deploying the autonomous vehicle in the real-world.

16. A system comprising:
a computer processor; and
non-transitory computer readable medium for causing the computer processor to perform operations comprising:
obtaining a current set of agent state vectors and a map data of a geographic region;
iteratively, through a plurality of diffusion timesteps, updating the current set of agent state vectors, wherein iteratively updating comprises:
processing, by a noise prediction model, the current set of agent state vectors, a current diffusion timestep of the plurality of diffusion timesteps, and the map data to obtain a noise prediction value,
generating a mean using the noise prediction value,
generating a distribution function according to the mean,
sampling a revised set of agent state vectors from the distribution function, and
replacing the current set of agent state vectors with the revised set of agent state vectors; and
outputting the current set of agent state vectors.

17. The system of claim 16, wherein the operations further comprise:
evaluating a guidance function using the current set of agent state vectors to generate a perturbation; and
revising the mean according to the perturbation.

18. The system of claim 16, wherein the operations further comprise:
generating a plurality of map element nodes for a plurality of map elements defined in map data, the plurality of map element nodes connected by a first plurality of edges based on relative positions between the plurality of map elements;
encoding the current set of agent state vectors through a first set of neural networks layers to generate a set of agent state vector encodings;
processing the set of agent state vector encodings through a self-attention layer to obtain first updated set of agent state vector encodings;
processing the first updated set of agent state vector encodings through a cross attention layer with the plurality of map element nodes to obtain second updated set of agent state vector encodings; and
processing the second updated set of agent state vector encodings through a second set of neural network layers to generate the noise prediction value.

19. A non-transitory computer readable medium comprising computer readable program code for causing a computer system to perform operations comprising:
obtaining a current set of agent state vectors and a map data of a geographic region;
iteratively, through a plurality of diffusion timesteps, updating the current set of agent state vectors, wherein iteratively updating comprises:
processing, by a noise prediction model, the current set of agent state vectors, a current diffusion timestep of the plurality of diffusion timesteps, and the map data to obtain a noise prediction value,
generating a mean using the noise prediction value,
generating a distribution function according to the mean,
sampling a revised set of agent state vectors from the distribution function, and
replacing the current set of agent state vectors with the revised set of agent state vectors; and
outputting the current set of agent state vectors.

20. The non-transitory computer readable medium of claim 19, wherein the operations further comprise:
evaluating a guidance function using the current set of agent state vectors to generate a perturbation; and
revising the mean according to the perturbation.
